(19) United States
(12) Patent Application Publication
(10) Pub. No.: US 2026/0193909 A1
(43) Pub. Date: Jul. 9, 2026

(54) LATCH FOR FRONT HOOD OF VEHICLE

(71) Applicant: Kiekert AG, Heiligenhaus (DE)

(72) Inventors: Xuanlang WANG, Changshu, Suzhou, Jiangsu (CN); Pingchun HE, Changshu, Suzhou, Jiangsu (CN); Shengjie TANG, Changshu, Suzhou, Jiangsu (CN)

(73) Assignee: Kiekert AG, Heiligenhaus (DE)

(21) Appl. No.: 19/131,991

(22) PCT Filed: Nov. 27, 2023
(86) PCT No.: PCT/CN2023/134398

§ 371 Date: May 22, 2025

(30) Foreign Application Priority Data
Nov. 28, 2022 (CN) 202223235237.7

(51) Int. Cl. E05B 83/24; E05B 15/04; E05B 77/38

(52) U.S. Cl. CPC E05B 83/243; E05B 15/04; E05B 77/38; E05B 2015/0455

(57) ABSTRACT

A latch for a front hood of a vehicle is provided. The latch comprising a housing (1), a catch (2) and a pawl (3) rotatably supported on the housing (1), and a torsion spring (4) fixed relative to the housing and comprising a first leg (41). The pawl (3) is configured to lock the catch (2) which locks a striker (5). The first leg (41) and the catch (2) are configured to abut against the striker (5) at opposite sides in a locked state of the striker. A free end of the first leg (41) is inserted into a receiving slot (6) formed in the housing (1) and is capable of sliding under the guidance of the receiving slot (6). Since the torsion spring and the catch clamp the striker at its two sides, noise generated by wobbling of the striker within the catch is eliminated. Furthermore, as the movement of the first leg of the torsion spring can be guided by the receiving slot of the housing, wobbling of the first leg of the torsion spring is prevented, resulting in more stable and reliable locking and unlocking processes.

### TECHNICAL FIELD

The present disclosure relates to a latch for a front hood of a vehicle, for locking or releasing the front hood by holding or releasing a striker attached thereto.

### BACKGROUND

A front hood of a vehicle, such as a hood of an engine compartment in a motor vehicle or a hood of a front trunk compartment in a new energy vehicle, is provided with a front hood latch for locking the hood to the body of the front compartment. A front hood latch of this type generally includes a housing provided with a striker slot, a catch mounted on the housing and configured to engage a striker attached to the hood, and a pawl for engaging the catch to keep it in a locked position. When the front hood falls down, the striker attached to the hood enters into the striker slot and contacts the catch to rotate the catch into a locked position, where the catch is engaged with the pawl, thereby keeping the catch and, therefore, the striker in the locked position.

A locking groove of the catch for engaging the striker has a size larger than a diameter of the striker, thus there is a gap between the catch and the striker. After the hood is closed, the gap between the catch and the striker results in wobbling of the striker in the locking groove due to vibration of the vehicle body and thus results in noise.

In addition, a simpler latch structure and more stable and reliable operation of components of a latch are consistently pursued in the field.

### SUMMARY OF THE DISCLOSURE

The present disclosure aims to solve at least one of the above problems or other problems existing in the prior art.

According to one aspect of the present disclosure, a latch for a front hood of a vehicle is provided for locking or releasing the hood by holding or releasing a striker attached to the hood, the latch comprises a housing fixed to a vehicle body, a catch and a pawl rotatably supported on the housing, and a torsion spring fixed relative to the housing. The catch is configured to lock the striker and the pawl is configured to lock the catch which locks the striker. The torsion spring comprises a first leg. The first leg and the catch are configured to abut against the striker at opposite sides in a locked state of the striker. A free end of the first leg is configured to be inserted into a receiving slot formed in the housing and be capable of sliding under guidance of the receiving slot.

In this exemplary technical solution, by providing the torsion spring, the torsion spring and the catch clamp the striker at its two sides in the locked state of the striker, so as to prevent wobbling of the striker during operation of the vehicle and in turn to eliminate the wobbling noise. As the free end of the first leg is inserted into the receiving slot and capable of sliding relative to the receiving slot, the receiving slot can guide movement of the first leg of the torsion spring and prevent wobbling of the first leg, resulting in more stable and reliable locking and unlocking processes.

According to an exemplary configuration, the housing comprises a main body and a first side wall projecting from the main body towards a side where the catch is located. The receiving slot is formed in the first side wall and one end wall of the receiving slot is configured to abut against the first leg in the locked state of the striker.

In this configuration, the position of an end wall (the lower end wall) of the receiving slot can avoid a downward wobbling of the first leg of the torsion spring, so as to improve the stability thereof. Furthermore, the lower end wall of the receiving slot supports the first leg of the torsion spring so that the first leg can clamp the striker more securely.

According to an exemplary configuration, the first leg is bent at its bent section towards the striker and the bent section is positioned to be able to contact the striker.

Compared with a straight leg, the design of the bent section on the first leg enables more contact between the first leg and the striker during a downward movement of the striker towards a locked position and an upward movement towards an unlocked position, so as to provide more stable support for the striker.

According to an exemplary configuration, the first leg further comprises a first straight section and a second straight section connected by the bent section, with an obtuse angle between the first straight section and the second straight section.

According to an exemplary configuration, a wire of the torsion spring has a rectangular cross section.

The torsion spring with a rectangular cross section has a planar surface in contact with the striker, thus has a larger contact area compared to a wire having a circular cross section, so as to clamp the striker more stably. According to an exemplary configuration, the torsion spring further comprises a second leg, and the housing further comprises a second side wall projecting from the main body and opposite to the first side wall. A free end of the second leg of the torsion spring abuts against the second side wall. The latch with such a configuration is simple in structure and easy to assemble.

According to an exemplary configuration, the catch is pivotally supported on the housing through a first shaft provided on the housing. The torsion spring is fixed to the first shaft.

According to an exemplary configuration, the pawl is pivotally supported on the housing through a second shaft provided on the housing. The torsion spring is fixed to the second shaft.

### BRIEF DESCRIPTION OF THE DRAWINGS

FIG. 1 shows a schematic perspective view of a latch for a front hood of a vehicle according to an exemplary embodiment of the present disclosure.

FIG. 2 shows a schematic front view of the latch in an unlocked state, in which a striker has entered into a striker slot.

FIG. 3 shows a schematic front view of the latch in a locked state.

FIG. 4 shows a schematic perspective view of the latch, seen from another view, in which a first leg of a torsion spring is received in a receiving slot.

FIG. 5 shows a schematic perspective view of the latch in FIG. 4, seen from yet another view.

### DETAILED DESCRIPTION

Embodiments of the present disclosure are described hereinafter with reference to the drawings. In the following description, many details are set forth in order to enable those skilled in the art to better understand and implement the present disclosure. However, it is apparent to those skilled in the art that the implementation of the present disclosure may not need some of these details.

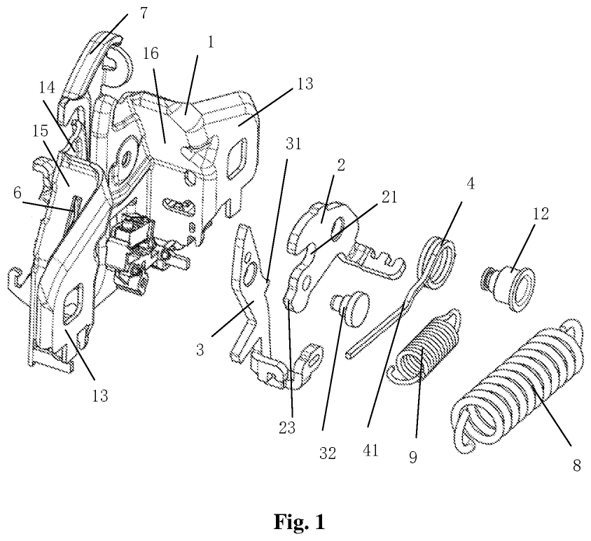

Referring to FIGS. 1-5, a latch for a front hood of a vehicle according to an exemplary embodiment of the present disclosure is shown. The front hood of the vehicle described herein includes but is not limited to a hood of an engine compartment of a motor vehicle. For example, for a new energy vehicle, a trunk compartment is provided at the corresponding front portion of the vehicle, and the latch of the present disclosure can also be applied to the hood of the trunk compartment. The front compartment of the vehicle can be opened or closed by the hood (not shown), to which a striker 5 is attached. The latch is fixed to the vehicle body (not shown) at the front compartment, and holds the hood in a closed position by locking the striker 5.

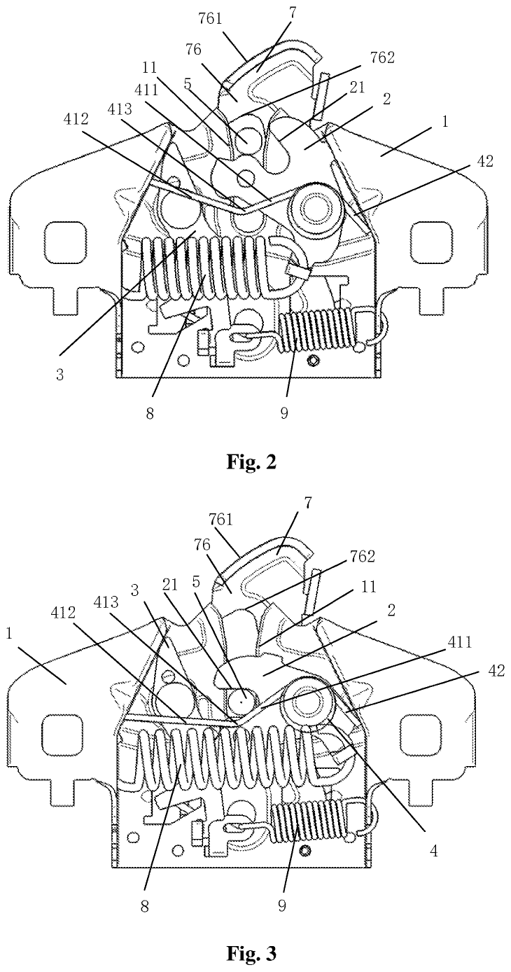

As shown in FIGS. 1-4, the latch includes a housing 1, a catch 2, a pawl 3, a first spring 8 and a second spring 9. The housing 1 includes mounting portions 13, through which the latch is fixed to the vehicle body. As shown in FIGS. 2 and 3, a striker slot 11 for holding the striker 5 is formed in the housing 1. As shown in FIG. 1, the catch 2 is pivotally supported on the housing 1 through a first shaft 12 provided on the housing 1. In the embodiment shown in FIGS. 1-4, the catch 2 is located on a right side of the striker slot 11 of the housing 1. However, the catch may be arranged on a left side of the striker slot 11. The catch 2 can be rotated between an unlocked position as shown in FIG. 2 and a locked position as shown in FIG. 3. One end of the first spring 8 is connected to the catch 2, and the other end is connected to the housing 1. The first spring 8 biases the catch 2 towards the unlocked position (in the clockwise direction in FIGS. 2 and 3). A locking groove 21 is formed in the catch 2 for locking the striker 5. In the locked position as shown in FIG. 3, the striker 5 is confined in the locking groove 21 and the striker slot 11, and cannot exit from the striker slot 11.

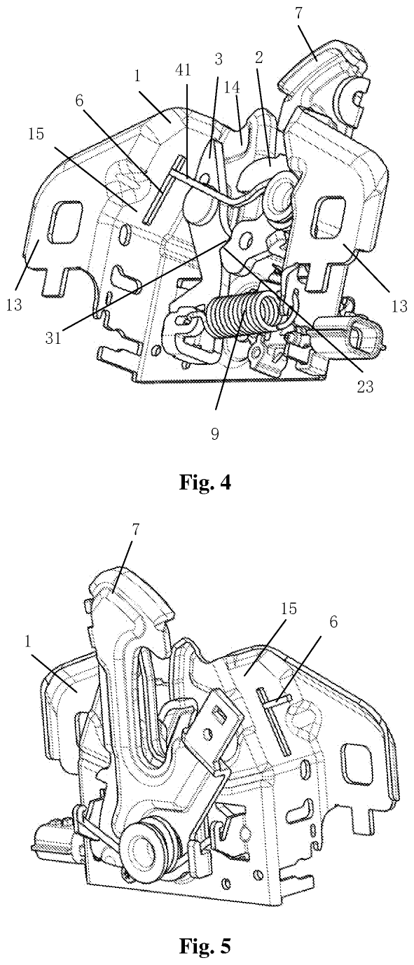

The pawl 3 is pivotally supported on the housing 1 via a second shaft 32, and located on the side (the left side in FIGS. 2 and 3) of the striker slot 11 opposite to the catch 2. Preferably, the first shaft 12, the second shaft 32 and a third shaft (described below) each may be a rivet connected to the housing 1 by riveting. As shown in FIGS. 1 and 4, the pawl 3 is provided with a first engaging portion 31 for abutting against a second engaging portion 23 of the catch 2 to prevent the catch 2 from rotating in an unlocking direction, thereby locking the catch 2 which holds the striker 5. As shown schematically in FIGS. 2 and 3, one end of the second spring 9 is connected to a lower end of the pawl 3, and the other end is connected to the housing 1. The pawl 3 is biased towards the locked position by the second spring 9. Illustratively, the pawl 3 may be coupled to an actuating lever (not shown) and rotated in the clockwise direction in FIG. 3 in response to an operation of the actuating lever, so that the first engaging portion 31 is disengaged from the second engaging portion 23 of the catch 2 to release the catch 2 from the locked position.

The latch further comprises a torsion spring 4 fixed relative to the housing. In the illustrated example, the torsion spring 4 is fixedly sleeved on the first shaft 12. A person skilled in the art would conceive that the torsion spring 4 can be fixed to other parts, e.g. to the second shaft 32. As shown in FIGS. 1-5, the torsion spring 4 comprises a first leg 41. The first leg 41 and the catch 2 are configured to abut against the striker 5 from a respective side in the locked state of the striker. Specifically, after the striker 5 enters into the striker slot 11 and then into the locking groove 21 of the catch 2 which is in the unlocked position as shown in FIG. 2, it continues to move towards the bottom of the striker slot 11 and presses against a lower side wall of the locking groove 21, so that the catch 2 is rotated towards the locked position. Upon the striker 5 coming into contact with the first leg 41 of the torsion spring 4 during the downward movement, it presses the first leg 41 downwards, so that energy is accumulated in the torsion spring 4. When the catch 2 is rotated to the locked position abutting against the pawl 3, due to the action of the first engaging portion 31 of the pawl 3, the catch 2 can no longer rotate to the unlocked position. The first leg 41, due to the energy accumulated in the torsion spring 4, tends to rotate towards the unlocked position (in the clockwise direction in FIG. 3) so as to closely abut against the striker 5 on its lower side as shown in FIG. 3, and meanwhile, an upper wall of the locking groove 21 of the catch 2 abuts against the striker 5 on its upper side, so that the striker 5 is clamped between the two. By means of the torsion spring 4, in a locked state the striker 5 can be held at its both sides by the torsion spring 4 and the catch 2, avoiding wobbling during operation of the vehicle and thus eliminating the wobbling noise. Furthermore, as the free end of the first leg 41 is inserted into a receiving slot 6 formed in the housing 1 and capable of sliding relative to the receiving slot 6, the receiving slot 6 can guide movement of the first leg 41 of the torsion spring and prevent wobbling of the first leg 41, resulting in more smooth and reliable locking and unlocking processes.

As an example, as shown in FIGS. 1, 4, and 5, the housing 1 comprises a main body 14 and a first side wall 15 projecting from the main body 14 towards a side where the catch 2 is located. The receiving slot 6 is formed in the first side wall 15 and configured such that a lower end wall of the receiving slot 6 abuts against the first leg 41 in the locked state of the striker. In other words, when the striker 5 is in the locked state, the first leg 41 is blocked by the lower end wall of the receiving slot 6. The position of the lower end wall of the receiving slot 6 can avoid a downward wobbling of the first leg 41 of the torsion spring 4, so as to improve the stability thereof. Furthermore, the lower end wall of the receiving slot 6 supports the first leg 41 of the torsion spring 4 so that the first leg can clamp the striker 5 more securely.

Preferably, as shown in FIGS. 2-4, the first leg 41 comprises a first straight section 411, a second straight section 412, and a bent section 413 between the first straight section 411 and the second straight section 412. The bent section 413 is positioned under the striker 5 and is able to contact the striker. Preferably, the angle between the first straight section 411 and the second straight section 412 is an obtuse angle. The bent section 413 surrounds a lower portion of the cylindrical striker 5. Compared with a straight leg, the design of the bent section of the first leg 41 enables more contact between the first leg 41 and the striker 5 during both the downward movement of the striker 5 towards the locked position and the upward movement towards the unlocked position, so as to provide more stable support for the striker 5.

Preferably, as shown in FIGS. 1, 4, and 5, a wire of the torsion spring 4 has a rectangular cross section. The torsion spring 4 with such a structure has a planar surface in contact with the striker 5, and thus has a larger contact area compared to a wire with a circular cross section, so as to clamp the striker 5 more stably.

As shown in FIG. 1, the torsion spring further comprises a second leg 42. The housing 1 further comprises a second side wall 16 projecting from the main body 14 and opposite to the first side wall 15. A free end of the second leg 42 of the torsion spring abuts against the second side wall 16. The latch with such a configuration is simple in structure and easy to assemble.

As shown in FIGS. 1-5, the latch further includes an auxiliary locking member 7 provided on a side of the housing 1 away from the mounting portions 13 and pivotally supported on the housing 1 through the third shaft. The auxiliary locking member 7 includes a locking portion 76 for locking the striker 5. The locking portion 76 is disposed outside the striker slot 11 and on a traveling path of the striker 5, and can be rotated between an auxiliary locking position where the striker 5 which exits from the striker slot 11 is locked, and an auxiliary unlocking position where the auxiliary locking member 7 is rotated and the locking portion 76 is moved away from the traveling path of the striker 5. As an example, the auxiliary locking member 7 may be connected to an operating lever (not shown). By manipulating the operating lever, the auxiliary locking member 7 can be rotated toward the auxiliary unlocking position to release the striker. Referring to FIGS. 1 to 5, an operation of the front hood latch will be described hereinafter in an exemplary manner.

First, when closing the front hood, the striker 5, moved with the closing hood, abuts against the outer edge 761 of the locking portion 76 of the auxiliary locking member 7 disposed on the traveling path of the striker 5. As a result of the abutment of the striker 5 against the locking portion 76, the auxiliary locking member 7 is rotated in a clockwise direction in FIG. 2 towards the auxiliary unlocking position, and out of the traveling path of the striker 5, thereby opening the striker slot 11 of the housing 1.

The striker 5 enters into the opened striker slot 11, and further enters into the locking groove 21 of the catch 2 which is in the unlocked position. Then, the striker 5 that has entered into the locking groove 21 continues to move towards the bottom of the striker slot 11 and presses against the lower side wall of the locking groove 21, so that the catch 2 is rotated towards the locked position.

Upon the striker 5 coming into contact with the first leg 41 of the torsion spring 4 during the downward movement, it presses the first leg 41 downwardly. The free end of the first leg 41 slides in the receiving slot 6, thereby the torsion of the first leg 41 is guided and energy is accumulated in the torsion spring 4. The catch 2 is brought into the locked position as shown in FIG. 3 when it is rotated to a position where the second engaging portion 23 of the catch 2 abuts against the first engaging portion 31 of the pawl 3. The front hood is kept in a completely closed state by means of the latch. Due to the action of the first engaging portion 31 of the pawl 3, the catch 2 can no longer rotate to the unlocked position. The first leg 41, due to the energy accumulated in the torsion spring 4, tends to rotate towards the unlocked position (in the clockwise direction in FIG. 3) so as to closely abut against the striker 5 on its lower side as shown in FIG. 3, and meanwhile, an upper wall of the locking groove 21 of the catch 2 abuts against the striker 5 on its upper side, so that the striker 5 is clamped between the two.

When opening the hood, the pawl 3 is actuated to disengage the first engaging portion 31 of the pawl 3 from the second engaging portion 23 of the catch 2, so as to release the catch 2 from the locked position.

After the catch 2 is released, the force exerted by the first spring 8 rotates the catch 2 towards the unlocked position. The striker 5 is pushed upwards by the catch 2 and the first leg 41 of the torsion spring 4 towards an open end of the striker slot 11 of the housing 1.

The striker 5 is moved upwards until it is brought into abutment with an inner edge 762 of the locking portion 76 of the auxiliary locking member 7 which is disposed on the travelling path of the striker 5, whereby the striker 5 is stopped in the vicinity of the open end of the striker slot 11. The opening operation of the front hood is stopped temporarily, and the hood is popped up to a predetermined open position.

When the hood is required to be completely opened, the auxiliary locking member 7 is rotated towards the auxiliary unlocking position. The locking portion 76 is rotated out of the traveling path of the striker 5, whereby the striker slot 11 is opened. This allows the striker 5 to exit from the striker slot 11, whereby the hood is opened completely.

It should be pointed out that the above-mentioned embodiments should only be regarded to be exemplary, and the present disclosure is not limited to these embodiments. By considering the contents of the specification, those skilled in the art can make various changes and modifications without departing from the scope or spirit of the present disclosure. The real scopes of the present disclosure are defined by the appended claims and their equivalents.

1. A latch for a front hood of a vehicle, wherein, the latch is configured for locking or releasing the front hood by holding or releasing a striker attached to the hood, wherein the latch comprises:
a housing fixed to a vehicle body;
a catch rotatably supported on the housing and configured to lock the striker;
a pawl rotatably supported on the housing and configured to lock the catch;
a torsion spring fixed relative to the housing and comprising a first leg, wherein the first leg and the catch are configured to abut against the striker respectively at opposite sides in a locked state of the striker, and a free end of the first leg is configured to be inserted into a receiving slot formed in the housing and be capable of sliding under guidance of the receiving slot.

2. The latch according to claim 1, wherein the housing comprises a main body and a first side wall projecting from the main body towards a side where the catch is located, wherein the receiving slot is formed in the first side wall and is configured such that one end wall of the receiving slot abuts against the first leg in the locked state of the striker.

3. The latch according to claim 1, wherein the first leg is bent at its bent section towards the striker and the bent section is positioned to be able to contact the striker.

4. The latch according to claim 3, wherein the first leg further comprises a first straight section and a second straight section connected by the bent section, with an obtuse angle between the first straight section and the second straight section.

5. The latch according to claim 1, wherein a wire of the torsion spring has a rectangular cross section.

6. The latch according to claim 2, wherein the torsion spring further comprises a second leg, and the housing further comprises a second side wall projecting from the main body and opposite to the first side wall, wherein a free end of the second leg of the torsion spring abuts against the second side wall.

7. The latch according to claim 1, wherein the catch is pivotally supported on the housing through a first shaft provided on the housing, wherein the torsion spring fixed to the first shaft.

8. The latch according to claim 1, wherein the pawl is pivotally supported on the housing through a second shaft provided on the housing, wherein the torsion spring is fixed to the second shaft.
